(19) United States
(12) Patent Application Publication
(10) Pub. No.: US 2026/0028149 A1
(43) Pub. Date: Jan. 29, 2026

(54) Sleeve and Method for Producing a Sleeve

(71) Applicant: Henkel AG & Co. KGaA, Duesseldorf (DE)

(72) Inventors: Peter Rushe, Duesseldorf (DE); Karsten Wolf, Mettmann (DE); Kai Ruthe-Steinsiek, Duesseldorf (DE)

(21) Appl. No.: 19/343,294

(22) Filed: Sep. 29, 2025

Related U.S. Application Data
(63) Continuation of application No. PCT/EP2024/057899, filed on Mar. 25, 2024.

(30) Foreign Application Priority Data
Apr. 3, 2023 (EP) 23166337.8

(51) Int. Cl. B65D 3/04; B31F 7/00; B65D 77/06; B65D 83/76

(52) U.S. Cl. CPC B65D 3/04; B31F 7/004; B31F 7/006; B65D 77/06; B65D 83/76

(57) ABSTRACT

The invention relates to a sleeve for receiving a filling product, wherein the sleeve has a proximal end comprising a proximal abutting edge, and a distal end comprising a distal abutting edge, and a sleeve wall extending between the proximal end and the distal end and delimiting a receiving space for the filling product, wherein the sleeve wall comprises an inner side facing the receiving space and an outer side facing away from the receiving space and wherein the sleeve is produced from a material comprising fibers. The invention is characterized in that at least one abutting edge of the sleeve is covered by a material portion resting against the sleeve wherein, in a region adjoining the abutting edge, the material portion covering the abutting edge rests against both the inner side and the outer side of the sleeve wall.

The invention relates to a sleeve for receiving a filling product and to a method for producing such a sleeve. Finally, the invention relates to the use of such a sleeve as a cartridge in a cartridge gun.

For professional applications and private use, various viscous materials such as silicone, acrylic and adhesives are supplied as standard in cartridges from which the material can be dispensed using a cartridge gun. Commercially available cartridges are often made of thick-walled plastics material.

In the wake of increased environmental and sustainability awareness, efforts are already underway to replace thick-walled plastics cartridges with a combination of film bags that hold the viscous material and sleeves that hold the film bags and are made of a more sustainable and easily recyclable material, such as cardboard.

For example, DE 91 16 065 describes a device for processing materials packaged in film tubes, in which a film tube filled with a viscous material is received in an outer sleeve spirally wound from a plurality of paper layers, which in turn can be inserted into a conventional cartridge gun. The plastics material content of such systems is significantly reduced compared to conventional cartridges. After being emptied, the outer sleeve can be separated from the film bag and both components can be fed into the respective recycling streams. Cardboard sleeves are often designed as winding sleeves, as disclosed in DE 91 16 065, in which a paper or cardboard strip is spirally wound one over the other in a plurality of layers to form the sleeve and then glued accordingly.

A disadvantage of cardboard sleeves is that they are, in some respects, less robust than cartridges made entirely of plastics material. In particular, paper and cardboard react strongly to moisture due to their hygroscopic properties. They absorb and hold moisture from their environment. As a result, the pulp fibers in the paper material swell, which can cause a sleeve made of such a material to deform under the influence of moisture, losing its geometry and stability and possibly becoming unusable. When using winding sleeves, the paper strip can become partially or completely unwound.

On construction sites, it is inevitable that material stocks are exposed to the weather, especially rain, for a certain period of time and/or are stored in rooms with very high humidity. These moisture influences can cause the cardboard tubes to swell in the manner described above and to lose their shaping and stabilizing properties with regard to the tubular bag they contain and their use in a cartridge gun.

It is therefore an object of the invention to provide a sleeve for receiving a filling product that overcomes the disadvantages of the prior art and has improved moisture resistance compared to known sleeves. A further object of the invention is to provide a method for producing such a sleeve.

These objects are solved by a sleeve having the features of claim 1 and by a method for producing such a sleeve having the features of claim 10.

The dependent claims relate to specific embodiments and developments of the invention.

According to claim 1, the invention is a sleeve for receiving a filling product, wherein the sleeve has a proximal end comprising a proximal abutting edge, and a distal end comprising a distal abutting edge, and a sleeve wall extending between the proximal end and the distal end and delimiting a receiving space for the filling product, wherein the sleeve wall comprises an inner side facing the receiving space and an outer side facing away from the receiving space, and wherein the sleeve is produced from a material comprising fibers. The invention is characterized in that at least one abutting edge of the sleeve is covered by a material portion resting against the sleeve, wherein, in a region adjoining the abutting edge, the material portion covering the abutting edge rests against both the inner side and the outer side of the sleeve wall.

In other words, the invention provides that at least one abutting edge of a sleeve produced from a material comprising fibers is covered by a material portion that extends adjacent to the abutting edge over at least a region of the inner side and the outer side of the sleeve wall. In this way, it can be prevented or at least made more difficult for moisture to penetrate directly into the material of the sleeve via the otherwise exposed abutting edges and lead to rapid swelling of the fibers and therefore to destabilization of the material.

It has been shown that moisture absorption into the material comprising fibers occurs primarily via the exposed abutting edges, i.e. the edges along which the material was cut in previous production steps. Such abutting edges are typically present at both ends of a core, and in the case of winding cores also along the edges of the wound paper strips. However, these are often covered by a label carrying product information and are therefore already protected to a certain extent from external moisture, so that moisture ingress into the material occurs substantially via the open abutting edges at the two ends of the sleeve.

By covering these abutting edges with at least one separate material portion according to the invention, the penetration of moisture can be prevented or at least reduced for a significant period of time.

According to one embodiment of the invention, both the proximal abutting edge and the distal abutting edge are covered by at least one material portion resting against the sleeve. It can be provided that the proximal abutting edge and the distal abutting edge are covered by two different material portions.

According to one embodiment of the invention, each material portion is strip-shaped and extends from the abutting edge over a maximum of 10% of the length of the sleeve. In other words, a separate, strip-shaped material portion is placed against both the proximal end and the distal end of the sleeve, which separate, strip-shaped material portion covers the particular abutting edge and extends in a narrow region adjoining the abutting edge both along the inner side and along the outer side of the sleeve wall. It can be provided that the material portion is glued to the inner side and/or the outer side of the sleeve wall, optionally only at certain points.

If the sleeve is provided with a label carrying product information, this is preferably arranged on the sleeve in such a way that it at least partially covers the portions of the material portions adjoining the outer side of the sleeve wall.

It is an advantage of such a design that the sleeve can be produced with the material portions covering the abutting edges and can be filled with a tubular bag containing a viscous material, while a label that can optionally be adapted to a specific target market can only be individually applied to the sleeve at a later point in time.

An alternative and particularly efficient embodiment of the invention in terms of production technology provides that both the proximal abutting edge and the distal abutting edge are covered by the same material portion, which extends over the entire length of the sleeve, completely covers the outer side of the sleeve wall and is guided over the two abutting edges of the sleeve into the receiving space in such a way that it rests, at least in some regions, against the inner side of the sleeve wall.

In other words, it can also be provided that a single, larger material portion is placed against the sleeve in such a way that its edge regions extending beyond the two ends of the sleeve are folded over the abutting edges of the sleeve and guided inward into the receiving space of the sleeve, where they rest against the inner wall of the sleeve at least in a narrow region adjoining the abutting edges.

It can be provided that the material portion is printed on at least in some regions and has the function of a label. An advantage of this design is that by placing the printed material portion against the sleeve, both the abutting edge protection and the label carrying the product information are applied in a single production step.

According to one proposal of the invention, the sleeve is made of a plant-fiber-based material. For example, the sleeve can be produced from paper or cardboard.

According to a further proposal of the invention, the material portion is produced from paper. If both the sleeve and the at least one material portion are produced from paper or cardboard, the combination of the sleeve and material portion can be recycled separately. Of course, it is also possible to cover it with a portion of material made of another material, for example plastics material. However, such a composite is less easily recyclable. Furthermore, it has been shown that in order to provide satisfactory protection of the abutting edges against moisture, it is generally sufficient to cover them with a material portion made of paper.

The invention also relates to the use of a sleeve according to any of claims 1 to 8 as a cartridge in a cartridge gun, wherein the sleeve is used to receive a tubular bag filled with a viscous material.

In addition, a sleeve according to the invention can of course also be used for other applications, for example as a receptacle for an adhesive in a glue stick and therefore as a replacement for the plastics sleeve otherwise commonly used there.

Finally, the invention also relates to a method for producing a sleeve according to any of claims 1 to 8, comprising the following steps:
forming a sleeve from a material comprising fibers, wherein the sleeve comprises a proximal abutting edge and a distal abutting edge;
applying an adhesive to at least a region of the outer side of the sleeve wall;
resting at least one material portion against the sleeve in such a way that at least one of the two abutting edges is covered by the at least one material portion, wherein, in a region adjoining the abutting edge, the material portion rests against both the inner side and the outer side of the sleeve wall and is fixed to the outer side of the sleeve wall by the applied adhesive.

The material portion can be placed against the sleeve, for example, by first gluing the material portion to the outer side of the sleeve wall and then, for example using a suitable movable piston, hammering it in and folding it inward over the abutting edge. Fixing the material portion on the inner side of the sleeve wall, for example by gluing, is basically possible, but generally not necessary.

According to one embodiment of the method according to the invention, it is provided that a first and a second strip-shaped material portion are placed against the sleeve in such a way that the first material portion covers the proximal abutting edge and the second material portion covers the distal abutting edge.

An alternative embodiment of the method provides that a printed material portion is placed against the sleeve, which material portion covers both the proximal abutting edge and the distal abutting edge and at the same time has the function of a label.

### BRIEF DESCRIPTION OF THE DRAWINGS

In the following, the invention is explained in more detail by means of an exemplary embodiment and with reference to the attached figures. In the figures:

FIG. 1: is a perspective view of a sleeve according to the invention in a first embodiment;

FIG. 2: is a top view a material portion in a first embodiment;

FIG. 3: is a perspective view of a sleeve according to the invention in a second embodiment;

FIG. 4: is a top view a material portion in a second embodiment.

### DETAILED DESCRIPTION OF EMBODIMENTS OF THE INVENTION

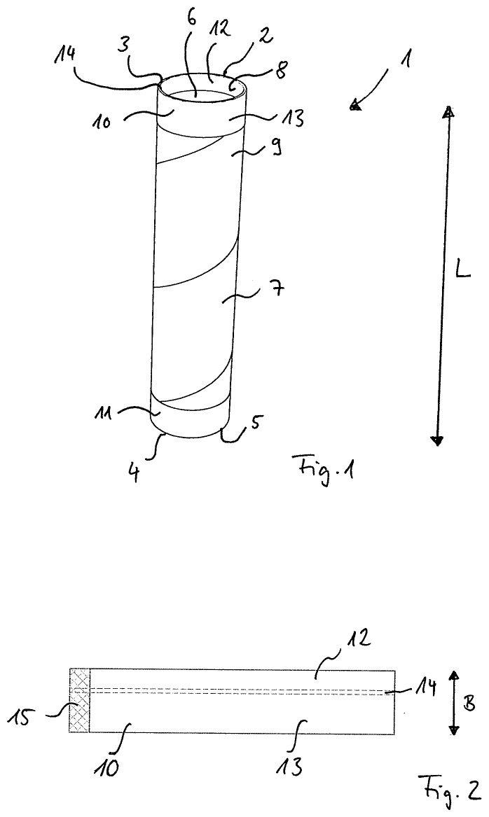

FIG. 1 shows a sleeve, designated as a whole by “1”, for receiving a filling product. The sleeve 1 is produced from a paper material as a winding sleeve and can be used as a cartridge in a cartridge gun not shown here.

The sleeve 1 has a proximal end 2 comprising a proximal abutting edge 3, a distal end 4 comprising a distal abutting edge 5, and a sleeve wall 7 extending between the proximal end 2 and the distal end 4 and delimiting a receiving space 6 for the filling product. When the sleeve 1 is used as a cartridge, for example, a tubular bag containing a viscous material can be introduced into the receiving space 6. The sleeve wall 7 comprises an inner side 8 facing the receiving space 6 and an outer side 9 facing away from the receiving space 6.

The proximal abutting edge 3 is covered by a material portion 10; the distal abutting edge 5 is covered by a material portion 11. The two material portions 10, 11 are produced from paper and are strip-shaped. FIG. 2 shows an example of material portion 10. The material portion 11 is designed in the same way.

The dimensions of the strip-shaped material portions 10, 11 are selected such that, when resting against the sleeve 1, they completely cover the particular abutting edge 3, 5 and, in a region adjoining the abutting edges 3, 5, they rest against both the inner side 8 and the outer side 9 of the sleeve wall 7. In FIGS. 1 and 2, the portion of the material portion 10 adjoining the inner side 8 of the sleeve wall 7 is designated by 12, while the portion adjoining the outer side 9 of the sleeve wall 7 is designated by 13. The portions 12 and 13 are separated from each other by a narrow portion 14 that, when resting against the sleeve 1, covers the abutting edge 3. An edge region 15 represents an overlap region in which the two short-side ends of the material portion 10 overlap when resting against the sleeve 1.

The material portion 10 is glued to the outer side 9 of the sleeve wall 7 within the portion 13. In an analogous manner, the material portion 11 is fixed to the outer side 9 by gluing. The portion 12 of the material portion 10 and the corresponding portion of the material portion 11 only rest loosely against the inner side 8 of the sleeve wall 7.

A label carrying product information (not shown in the figures) can be arranged on the sleeve 1 in such a way that it at least partially covers the portions 13 of the material portions 10, 11 adjoining the outer side 9 of the sleeve wall 7.

The sleeve 1 has a length L of approximately 22 cm. The material portions 10, 11 have a width B of approximately 3.2 cm, wherein the portion 13 has a width of approximately 2 cm and the portion 12 has a width of approximately 1 cm. The two material portions 10, 11 thus extend from the abutting edges 3, 5 over no more than 10% of the length of the sleeve 1.

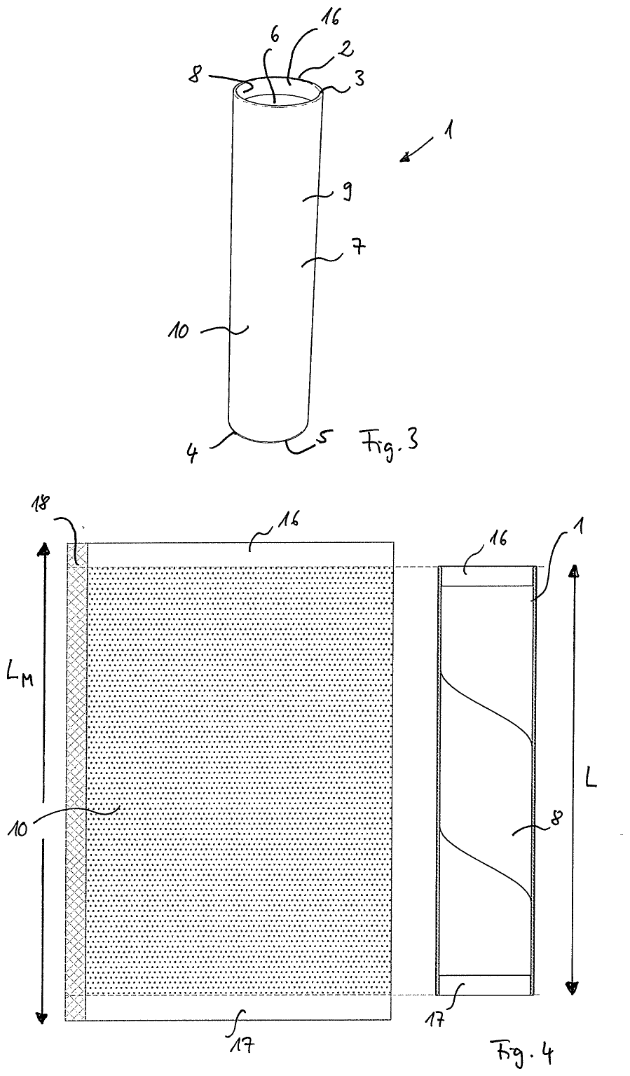

FIG. 3 shows another embodiment of a sleeve 1 produced from a paper material. In contrast to the sleeve 1 shown in FIG. 1, a single material portion 10 is placed against the sleeve 1 of FIG. 3, which single material portion covers both the proximal abutting edge 3 and the distal abutting edge 5 and extends over the entire length of the sleeve 1. The material portion 10 completely covers the outer side 9 of the sleeve wall 7 and is guided over the two abutting edges 3, 5 of the sleeve 1 into the receiving space 6 such that it rests against the inner side 8 of the sleeve wall 7.

The material portion 10 shown in FIGS. 3 and 4 is also produced from paper. It is printed with product information at least in some regions, which is not shown in FIG. 3, and thus simultaneously has the function of a label.

FIG. 4 shows the material portion 10, the length of which L_{M} extends beyond the length L of the sleeve 1 so that edge portions 16, 17 of the material portion 10 can be folded inward over the abutting edges 3, 5 of the sleeve 1 and come to rest on the inner side 8 of the sleeve wall 7, which can also be seen for the edge portion 16 in FIG. 3. In addition to the material portion 10, the sleeve 1 is shown in a longitudinal section in FIG. 4.

A region 18 represents an overlap region in which the two long ends of the material portion 10 overlap when resting against the sleeve 1.

Due to the covering of the abutting edges 3, 5 of the sleeve 1 produced from a paper material by material portions 10, 11 made of paper, the abutting edges 3, 5 are better protected against moisture so that the sleeve 1 has an overall improved moisture resistance and retains its shape and stability significantly longer when exposed to moisture.

What is claimed is:

1. A sleeve (1) for receiving a filling product, wherein the sleeve (1) has a proximal end (2) comprising a proximal abutting edge (3), and a distal end (4) comprising a distal abutting edge (5), and a sleeve wall (7) extending between the proximal end (2) and the distal end (4) and delimiting a receiving space (6) for the filling product, wherein the sleeve wall (7) comprises an inner side (8) facing the receiving space (6) and an outer side (9) facing away from the receiving space (6), and wherein the sleeve (1) is produced from a material comprising fibers, wherein at least one abutting edge (3, 5) of the sleeve (1) is covered by a material portion (10, 11) resting against the sleeve (1), wherein, in a region adjoining the abutting edge (3, 5), the material portion (10, 11) covering the abutting edge (3, 5) rests against both the inner side (8) and the outer side (9) of the sleeve wall (7).

2. The sleeve (1) according to claim 1, wherein both the proximal abutting edge (3) and the distal abutting edge (5) are covered by at least one material portion (10, 11) resting against the sleeve (1).

3. The sleeve (1) according to claim 2, wherein the proximal abutting edge (3) and the distal abutting edge (5) are covered by two different material portions (10, 11).

4. The sleeve (1) according to claim 1, wherein each material portion (10, 11) is strip-shaped and extends from the abutting edge (3, 5) over a maximum of 10% of the length of the sleeve (1).

5. The sleeve (1) according to claim 1, wherein both the proximal abutting edge (3) and the distal abutting edge (5) are covered by the same material portion (10), which extends over the entire length of the sleeve (1), completely covers the outer side (9) of the sleeve wall (7) and is guided over the two abutting edges (3, 5) of the sleeve (1) into the receiving space (6) in such a way that it rests, at least in some regions, against the inner side (8) of the sleeve wall (7).

6. The sleeve (1) according to claim 5, wherein the material portion (10) is printed on at least in some regions and has the function of a label.

7. The sleeve (1) according to claim 1, wherein the sleeve (1) is produced from a plant-fiber-based material.

8. The sleeve (1) according to claim 1, wherein the material portion (10) is produced from paper.

9. A method for producing a sleeve (1) according to claim 1, comprising following steps of:
forming a sleeve (1) from a material comprising fibers, wherein the sleeve (1) comprises a proximal abutting edge (3) and a distal abutting edge (5);
applying an adhesive to at least one region of the outer side (9) of the sleeve wall (7);
resting at least one material portion (10) against the sleeve (1) such that at least one of the two abutting edges (3, 5) is covered by the at least one material portion (10), wherein, in a region adjoining the abutting edge (3, 5), the material portion (10) rests against both the inner side (8) and the outer side (9) of the sleeve wall (7) and is fixed to the outer side (9) of the sleeve wall (7) by the applied adhesive.

10. The method according to claim 9, wherein a first and a second strip-shaped material portion (10, 11) are placed against the sleeve (1) in such a way that the first material portion (10) covers the proximal abutting edge (3) and the second material portion (11) covers the distal abutting edge (5).

11. The method according to claim 9, wherein a printed material portion (10) is placed against the sleeve (1), which material portion covers both the proximal abutting edge (3) and the distal abutting edge (5) and at the same time has the function of a label.

12. A cartridge for use in a cartridge gun, said cartridge comprising a sleeve (1) according to claim 1, wherein the sleeve (1) is capable of receiving a tubular bag filled with viscous material.
